(19) United States
(12) Patent Application Publication
(10) Pub. No.: US 2026/0300783 A1
(43) Pub. Date: Oct. 1, 2026

(54) COMPUTER-BASED SYSTEMS AND METHODS FOR MACHINE LEARNING BASED EXCEPTION PREDICTIONS

(71) Applicant: Broadridge Financial Solutions, LLC, Lake Success, NY (US)

(72) Inventors: Neha Singh, Lake Success, NY (US); Jenny Lin, Toronto (CA); Santosh Vazarkar, Lake Success, NY (US); Kishore Seshagiri, Hyderabad (IN); Christopher Bell, Lake Success, NY (US); Fabian Knoch, Lake Success, NY (US); Martin Walker, London (GB); Matthew Pountain, London (GB); Jitendra Kumnar, Lake Success, NY (US); Ravikrishna Kodamagulla, Hyderabad (IN); Prabhakar Akella, Hyderabad (IN); Sebastian Castillosanchez, Lake Success, NY (US); Vivekananda Avvari Naga, Hyderabad (IN); Srinivas Sagi, London (GB); Jom J Varghese, Hyderabad (IN); Carolyn Jones, London (GB)

(21) Appl. No.: 19/699,610

(22) Filed: Jun. 5, 2026

Related U.S. Application Data
(63) Continuation of application No. PCT/IB2024/062311, filed on Dec. 6, 2024.

(30) Foreign Application Priority Data
Dec. 6, 2023 (IN) 202331083122
Dec. 7, 2023 (IN) 202331083400

(51) Int. Cl. G06N 5/045

(52) U.S. Cl. CPC G06N 5/045

(57) ABSTRACT

A failure prediction method including a predicting flow and a model training flow, the predicting flow including receiving a natural language input from a client computer, translating the input into a task by a LLM, selecting a ML model dedicated to the task, receiving first data, converting the first data to second data of a predetermined format, immediately applying, the ML model on the second data for predicting an output and providing a corresponding explanation, storing the second data and the output into historical data in a storage layer, translating the output and the explanation into a prediction in the natural language by the LLM, and transmitting the prediction to the client computer and iterating the predicting flow for a predetermined number of time; and the model training flow including retrieving the historical data from the storage layer, and training the ML model on the historical data.

### FIELD OF TECHNOLOGY

The present disclosure generally relates to systems and methods for machine learning based exception predictions from historical data.

### BACKGROUND OF TECHNOLOGY

Most post-trade systems in use today are only able to provide pre-settlement and/or settlement exceptions and/or the operations teams are alerted to action on the exceptions. These settlement exceptions could range from static data correction to short fall in deliveries, that can be very expensive. Securities Static Data includes reference data about Securities. Securities pricing data includes market data information including price of securities.

Below definitions may be used in some aspects of technical problems and solutions that are addressed. These definitions are not restrictive but illustrative.

Trade Date—The date in which the trade was executed and entered into the post-trade system.

Transaction Date—The date in which a transaction (e.g., a trade date) was executed and entered into an exemplary post-transactional system of the present disclosure.

Settlement Date—The date at which the trade is settled and the cash and securities are exchanged between the counterparties.

Trader/Trading Desk/Trading Book—The trader or the trading desk department which executed the trade.

Transaction—an arrangement affecting a transfer of ownership and/or a financial component (e.g., benefit, reward, return, profit, liability, risk, loss, etc.) related to any asset of any asset class that may include inter alia, without limitation, one of the following in physical and/or virtual realms:
1. Equities (Stocks);
2. Fixed Income (Bonds);
3. Cash and Cash Equivalents (e.g., checking accounts, savings accounts, and money market funds);
4. Real Assets: Tangible assets such as real estate, commodities (oil, gold, etc.), and/or infrastructure;
5. Alternative Investments/investment vehicles associated with, for example without limitation, hedge funds, private equity, and venture capital;
6. Crypto assets (e.g., cryptocurrencies, non-fungible tokens (NFTs), blockchains, etc.); or
7. any combination thereof.

Transaction Facilitator—a party and/or a computer system that facilitates the transaction. For example, a Trader/Trading Desk/Trading Book are examples of various facilitators in transaction of securities (e.g., the trader or the trading desk department executes the trade).

Operations Console—Broadridge's single pane of glass operations desktop for operations team to monitor all aspects of post-trade operations and take actions.

Securities Static Data—Reference data about Securities.

Securities pricing data—Market data information including price of securities.

CSDR—Central Securities Depositories regulation.

TMPG—Treasury markets practices group.

T30 1 Settlement—Settlement cycle that will bring trade settlement to happen next day after trade date.

Transaction Static Data—data that includes reference data about transaction and/or underlining asset(s) (e.g., securities).

Transaction pricing data—data that includes market data information about transaction and/or underlining asset(s) (e.g., price of securities).

Recall—The ability of a model to find all the relevant cases within a data set. Mathematically, the recall is defined as the number of true positives divided by the number of true positives plus the number of false negatives.

Precision—The ability of a classification model to identify only the relevant data points. Mathematically, precision is the number of true positives divided by the number of true positives plus the number of false positives.

### SUMMARY OF DESCRIBED SUBJECT MATTER

This summary is provided to introduce concepts related to systems and methods for machine learning based exception predictions from historical data. This summary is not intended to identify key features or essential features of the claimed subject matter, nor is it intended to be used to limit the scope of the claimed subject matter.

In an aspect of the present disclosure, a method discloses predicting, by at least one computing device, an output and corresponding explanation associated with first data, wherein the predicting comprises: receiving, by at least one computing device, at least one input in a natural language from a first client computer; translating, by the at least one computing device executing a large language model (LLM), the at least one input into at least one task; selecting, by the at least one computing device, at least one predetermined machine learning (ML) model dedicated to the at least one task; receiving, by the at least one computing device, the first data from at least one second client computer; converting, by the at least one computing device, the first data to second data of a predetermined format; immediately applying, by the at least one computing device, the at least one predetermined ML model on the second data for predicting the output and providing the explanation; storing, by the at least one computing device, the second data and the output into historical data in a storage layer; translating, by the at least one computing device executing the LLM, the output and the explanation into a prediction in the natural language; and transmitting, by the at least one computing device, the prediction to the first client computer; iterating, by the at least one computing device, the predicting for a predetermined number of time; retrieving, by at least one computing device, the historical data from the storage layer; and training, by the at least one computing device, the at least one predetermined machine learning (ML) model on the historical data, wherein the training comprises: extracting, by the at least one computing device, a plurality of attributes form the historical data; identifying, by the at least one computing device, relevant attributes from the plurality of attributes for predictive analysis; generating, by the at least one computing device, a train dataset from a first portion of the historical data associated with the relevant attributes; generating, by the at least one computing device, a test dataset from a second portion of the historical data associated with the relevant attributes; training, by the at least one computing device, the at least one predetermined ML model on the train dataset; and testing, by the at least one computing device, the at least one predetermined ML model on the test dataset.

In an aspect of the present disclosure the present system comprises: one or more processors; and a memory in communication with the one or more processors and storing instructions that, when executed by the one or more processors, cause the one or more processors to: predict an output and corresponding explanation associated with first data, wherein the predicting comprises: receiving at least one input in a natural language from a first client computer; translating, by executing a large language model (LLM), the at least one input into at least one task; selecting at least one predetermined machine learning (ML) model dedicated to the at least one task; receiving the first data from at least one second client computer; converting, the first data to second data of a predetermined format; immediately applying the at least one predetermined ML model on the second data for predicting the output and providing the explanation; storing the second data and the output into historical data in a storage layer; translating, by executing the LLM, the output and the explanation into a prediction in the natural language; and transmitting the prediction to the first client computer; iterate the predicting for a predetermined number of time; retrieve the historical data from the storage layer; and train the at least one predetermined machine learning (ML) model on the historical data, wherein the training comprises: extracting a plurality of attributes form the historical data; identifying relevant attributes from the plurality of attributes for predictive analysis; generating a train dataset from a first portion of the historical data associated with the relevant attributes; generating a test dataset from a second portion of the historical data associated with the relevant attributes; training the at least one predetermined ML model on the train dataset; and testing the at least one predetermined ML model on the test dataset.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 illustrates an exemplary precision/recall-trade-off in accordance with at least some embodiments of the present disclosure.

FIG. 2 is a flowchart illustrating an exemplary ML model training process in accordance with at least some embodiments of the present disclosure.

FIG. 3 shows an exemplary correlation matrix between various attributes.

FIG. 4 is a block diagram illustrating an architecture of a fails prediction system 400 in accordance with at least some embodiments of the present disclosure.

FIG. 5 is a block diagram illustrating an exemplary implementation of the fails prediction gateway integrating a LLM and ML models in accordance with at least some embodiments of the present disclosure.

FIGS. 6A and 6B are flowcharts illustrating an exemplary fails prediction process in accordance with at least some embodiments of the present disclosure.

FIG. 7 depicts a block diagram of an exemplary computer-based system and platform in accordance with one or more embodiments of the present disclosure.

FIG. 8 depicts illustrative schematics of an exemplary implementation of the cloud computing/architecture(s) in which embodiments of a system for AI model training and inferencing may be specifically configured to operate in accordance with some embodiments of the present disclosure.

### DETAILED DESCRIPTION

Described herein are various embodiments of systems and methods that leverage machine learning (ML) to predict the likelihood of failure and/or other exceptions in transactions in various asset classes and/or transactional instruments (e.g., financial instruments, etc.) and/or transactional vehicles (e.g., investment vehicles) associate with any asset class, such as, without limitation, equities, fixed income, cash and cash equivalents, commodities, foreign currencies, cryptocurrencies, real estate, financial derivatives, exchange-traded funds (ETFs), mutual funds, precious metals, alternative investments, or any combination thereof. ML models may be built and/or trained on historical data of trades and/or may be fine-tuned to predict the likelihood of a trade exception, along with costs associated with the exception at real-time for any post-trade systems.

At least some embodiments of this disclosure may be directed to address transaction settlement failures in post-transaction (e.g., post-trade) processes that may lead to significant operational and/or financial costs for, in case of securities trading industry fail penalties, regulatory penalties including Treasury markets practices group (TMPG), Central Securities Depositories regulation (CSDR) penalties, mandatory buy-in costs etc. In at least some embodiments, the present disclosure may address, in case of securities trading, without limitation, the pressure on correctness in the transaction settlement may increase with the move towards T+1, where T+1 includes a Transaction Settlement cycle that will bring transaction (e.g., trade) settlement to happen next day after the transaction date (e.g., trade date).

At least some embodiments are designed to address a technological problem that the data which is a characteristic of the domain is of imbalanced nature. The number of failed trades may typically vary between 3%-10% of the actual trades.

At least some embodiments may be configured/programmed to use ML model(s) to predict all categories exceptions. It is understood that the present disclosure is not limited to predicting and actioning settlement fails. At least some embodiments may be configured/programmed to use ML model(s) to predict exceptions that may be trade affirmations, settlement matching, trade allocations, trade clearing, account maintenance, security master maintenance, market data feeds, and/or etc.

At least some embodiments of this disclosure may be directed to address settlement failures in post-trade processes that may lead to significant operational and/or financial costs for the industry with fail penalties, regulatory penalties including Treasury markets practices group (TMPG), Central Securities Depositories regulation (CSDR) penalties, mandatory buy-in costs etc. The pressure on the settlement teams will increase significantly with the move towards T+1, where

T+1 includes a Settlement cycle that will bring trade settlement to happen next day after trade date.

Described herein are various embodiments a process and/or method that leverages machine learning methods to predict the likelihood of trade failure and/or other exceptions in Equities and/or Fixed income markets. The machine learning model may be built and/or trained on historical data of trades and/or may be fine tuned to predict the likelihood of a trade exception, along with costs associated with the exception at real-time for any post-trade systems.

At least some embodiments are designed to address a technological problem that the data which is a characteristic of the domain is of imbalanced nature. The number of failed trades may typically vary between 3%-10% of the actual trades.

At least some embodiments may be configured/programmed to use ML model(s) to predict all categories exceptions. It is understood that the present disclosure is not limited to predicting and actioning settlement fails. At least some embodiments may be configured/programmed to use ML model(s) to predict exceptions that may be trade affirmations, settlement matching, trade allocations, trade clearing, account maintenance, security master maintenance, market data feeds, and/or etc.

In at least some embodiments, an exemplary ML based real-time predictor may leverage machine learning to predict the likelihood of failure for each transaction (e.g., trade) and/or the underlying drivers. Embodiments of the exception predictor solution can predict the likelihood of failure right from transaction date (e.g., trade date) till settlement date with the likelihood probability changing depending on the underlying factors through the transaction's (e.g., trade's) lifecycle.

At least some embodiments of the exception predictor solution can be integrated via multiple options including operations console dashboards, APIs, microservices, etc. For example, without limitation, there may be APIs that communicate between different layers (e.g., Model Servicing API; and/or Data Services REST API). In some embodiments, predicted results may be available in cloud-based storage that may be integrated with Generative Artificial Intelligence (GenAI) type interface (e.g., like ChatGPT-like interface).

At least some embodiments may include an operations consoler that may be configured/programmed to provide a “single pane of glass” operations desktop for operations team to monitor all aspects of post-transaction (e.g., post-trade) operations and/or take actions.

At least some embodiments may leverage an intermediate data ontology/harmonization layer that enables the models to be run agnostically on multiple post-transaction (e.g., post-trade) processing systems and/or extensible to front-office and/or middle office solutions.

At least some embodiments of the exception predictor solution with predictive algorithms may act as an early warning system to transaction (e.g., trade) operations and/or allow them to investigate on potential transaction (e.g., trade) failures and/or resolve. The system may be designed to be agnostic to underlying post-transaction (e.g., post-trade) systems and/or helps operations team bring greater operational efficiency and/or reduce operational risk as the industry moves to T+1. The exception predictor solutions may be also able to provide underlying drivers for operations team to investigate and/or resolve. In at least some embodiments, the illustrative exception predictor may be built to be within existing workflows of operations team and/or non-intrusive.

At least some embodiments of the exception predictor solution may be in a form of ‘human in the loop’ system that provides the likelihood of the failure but the actual resolution may be performed by human operator. Machine intelligence may be advanced to provide actual resolution automatically but this carries the risk of wrong actions performed by bots and/or hence.

At least some embodiments may utilize predictive algorithms of the present disclosure that can include one or more machine learning based models and/or method for predicting the likelihood of failure in terms of probability of failure, providing the underlying drivers and/or reasons that explains why the model has predicted x % probability. The predictions by the model(s) provide the ability of the model to act on various post-transaction (e.g., post-trade) solutions by leveraging a common data ontology. The predictive algorithm can be trained on multiple months of and/or associated linked data (e.g., securities data, settlement instructions data, stock record, balances data, etc.). The predictive algorithm may be able to provide a probability of transaction (e.g., trade) exception for each transaction (e.g., trade) at real-time and/or also the top underlying reasons.

In at least some embodiments, transaction data (e.g., trade data) may be a complex imbalanced data; the % of failures of overall transaction (e.g., trade) may be less, at least some embodiments of the algorithm may use resampling techniques and/or randomized synthetic data reflective of the original transaction (e.g., trade) during training phase to ensure high levels of accuracy.

In at least some embodiments, the predictive ML algorithms may be optimized for high recall with precision/recall-trade off. This ensures that ML algorithm may be always able to predict with high level of confidence about a transaction failure (e.g., trade failure). In at least some embodiments, an exemplary ML algorithm may suffer from moderately high false positives.

Embodiments of the predictive algorithm provides Explainability with numerical weights attribution to each data attribute's contribution to the failure reason.

At least some embodiments may be configured/programmed to ML models for classification, utilizing one or more of the following techniques:
Logistic regression,
Decision trees and Random Forests,
Gradient boosting trees,
Neural networks and/or Deep learning techniques, or
Any combination thereof.

At least some embodiments may be configured/programmed to utilize CatBoost to handle categorical data and the imbalanced nature of the data. At least some embodiments may be configured/programmed to utilize, additionally or instead of CatBoost, other techniques, but not limited to, XGBoost, deep learning, techniques built on Transformers such as Large Language Models, etc.

At least some embodiments may be configured/programmed to achieve Explainability using, without limitation, a technique of Explainable AI called Shapley Additive exPlanations (SHAP). The SHAP analyses the input attributes and computes their percentage of relevance/impact on the output probability of failure (e.g., risk levels, etc.). Explainability is not limited to using the SHAP only. At least some embodiments may be configured/programmed to utilize other techniques such as ELI5, etc. At least some embodiments may be configured/programmed to return a probability of failure along with percentages of relevance of the input attributes as part of the prediction. Examples of the attribute may include but not limited to trade identification, trade reference, price, quantity, instrument and security.

At least some embodiments may be configured/programmed to utilize the output that may be based on set of pre-identified attributes and the Explainability that may be based on how each of the attribute contribute towards the probability of a transaction failure (e.g., trade failure) (e.g., % of relevance towards the probability). At least some embodiments may be configured/programmed to utilize results to automatically manage workload, prioritization of the transactions (e.g., trades), etc.

At least some embodiments may be configured/programmed to optimize predictive algorithm(s) for high recall with precision/recall-trade-off. This ensures that the algorithm is always able to predict with a high level of confidence most of the transactions (e.g., trades) which are going to fail (e.g., 70%-80% of the transactions (e.g., trades) which are going to fail eventually). Due to the precision/recall trade off the exemplary algorithm may have false positives because the cost of missing a failure may be greater than the cost of attending to a transaction (e.g., trade) which may be lagged off as high probability of failing.

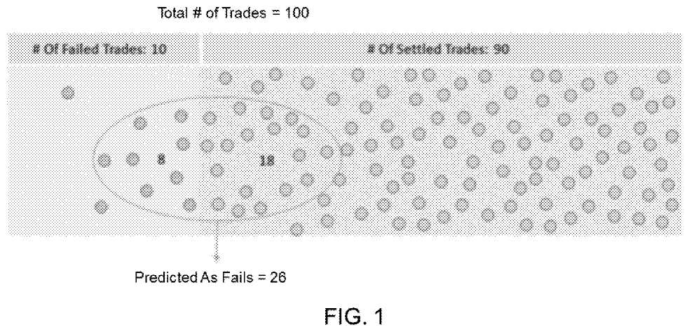

FIG. 1 illustrates an exemplary precision/recall-trade-off in accordance with at least some embodiments of the present disclosure. As an example, out of 100 trades, 10 failed and 90 successfully settled. Among 26 predicted failed trades, 8 are actual fails and 18 are falsely predicted. Then

Recall=Number of actual fails predicted/Total number of actual fails=8/10=80%; and

Precision=Number of actual fails predicted/Total number of fails predicted=8/26≈30%.

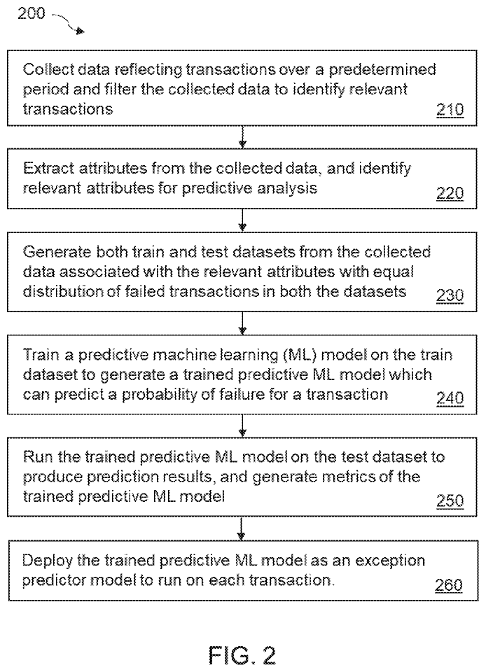

FIG. 2 is a flowchart illustrating an exemplary ML model training process 200 in accordance with at least some embodiments of the present disclosure. In at least some embodiments, the training process 200 may contribute to the development of the machine learning model using historical data. This process may result in the model identifying the exception patterns, reasons, underlying drivers and/or probability. Historical transaction data (e.g., trade data) along with the associated linked data may be made up of, in non-limiting case of securities-based transactions, Transaction data (e.g., securities data), settlement instructions data, stock record, balances data, etc. for example, the Historical source data (e.g., 12 months) including transaction data (e.g., trade data), securities reference data, stock record and/or cash balances data, etc. from the underlying post-trade system (and extensible to front office and/or middle office systems), may be extracted, transformed into a data ontology model and/or stored in a staging data source. For example, a settlement status may be defined as failed if the actual settlement date is greater than expected settlement date in the historical data.

In at least some embodiments, the training process 200 may include one or more of data preparation, data cleansing, data anonymization and/or ensuring confidential information may be protected. Additionally, the training process 200 may include one or more of data filtering, cleansing and/or univariate correlation analysis of each attribute to failure status. In at least some embodiments, all the attributes chosen may be categorical in nature.

As shown in FIG. 2, the training process 200 may include exemplary blocks 210-260 as described herein below.

In block 210, the training process 200 may collect data reflecting transactions over a predetermined period of time, e.g., 12 months, and filter the collected data to identify relevant transactions occurred during the period of time.

In block 220, the process 200 may extract attributes from the collected data, and identify relevant attributes among the extracted attributes for predictive analysis. In an example, more than 70 attributes are extracted from the collected data, but only 14 key attributes are identified as needed for predictive analysis. In some embodiments, 50 or more attributes may be extracted from the collected data including categorical attributes. In some embodiments, 70 or more attributes may be extracted from the collected data including categorical attributes. In some embodiments, 100 or more attributes may be extracted from collected data including categorical attributes. In some embodiments, 1000 or more attributes may be extracted from the collected data including categorical attributes. In some embodiments, 20-1,000 attributes that may be extracted from the collected data including categorical attributes. In some embodiments, a machine learning model may focus on, e.g., a subset of attributes (e.g., 20) that are of greatest influence for exception (e.g., Data Driven and/or SME Inputs).

In block 230, the process 200 may generate both train and test datasets from the collected data associated with the relevant attributes with, for example, equal distribution of failed transactions in both datasets. In some embodiments, the collected data may be segregated to train and test data in the order of, e.g., 80:20. Dataset imbalance may be addressed by resampling and/or random synthetic techniques.

In block 240, the process 200 may train a predictive machine learning (ML) mode on the train dataset to generate a trained predictive ML model which can predict a probability of failure for a transaction. In at least some embodiments, multiple ML classification models can be employed and/or applied on the dataset, such as a category boost model (e.g., Catboost). For example, Catboost may perform consistently well across multiple entities data, as, without limitation, illustrated below.

In at least some embodiments, the exception prediction model may be configured, by analyzing the training data, to accurately predicted 70-80% of the actual fails in the testing data. The model also predicts the likelihood of exception for each transaction (e.g., trade).

If new transaction patterns (e.g., trading patterns) start emerging (or) new assets (e.g., securities cryptocurrencies, bonds, funds, etc.) get transacted often, this could result in model drift (the model's performance suffers degradation). This may be addressed in embodiments of the solution by constant feedback and/or tuning of the model.

In block 250, the process 200 may run the trained predictive ML model on the test dataset to produce prediction results, and generate metrics of the trained predictive ML model. The metrics may be used to evaluate the performance of the trained predictive ML model. The choice of metrics depends on the type of problem to be solved (e.g., classification, regression, ranking).

Classification metrics may include:
Accuracy: The ratio of correctly predicted instances to the total instances.
Precision: The ratio of true positive predictions to the total positive predictions.
Recall (Sensitivity): The ratio of true positive predictions to the total actual positives.
F1 Score: The harmonic mean of precision and recall, useful for imbalanced datasets.
Confusion Matrix: A table showing true positives, false positives, true negatives, and false negatives.
ROC-AUC (Receiver Operating Characteristic-Area Under Curve): Measures the ability of the model to distinguish between classes.

Regression metrics may include:
Mean Absolute Error (MAE): The average of absolute differences between predicted and actual values.
Mean Squared Error (MSE): The average of squared differences between predicted and actual values.
Root Mean Squared Error (RMSE): The square root of MSE, providing error in the same units as the target variable.
R-squared (Coefficient of Determination): Indicates the proportion of the variance in the dependent variable that is predictable from the independent variables.

Other metrics may include:
Log Loss: Measures the performance of a classification model where the prediction is a probability value between 0 and 1.
Cross-Validation Scores: Provides an estimate of the model's performance on unseen data by splitting the data into training and validation sets multiple times.

These metrics help in understanding different aspects of model performance and are crucial for comparing and selecting the best model for a specific task.

At least some embodiments may be configured/programmed to monitor a ML model for any degradation of performance. Monitoring may be setup for model drift which is degradation of performance and data drift which may change in the quality of data from the training phase.

ML model(s) may be configured/programmed to be retrained to overcome the drift. In at least some embodiments, retraining can be triggered based on threshold of any chosen metric like accuracy, precision, recall, etc. In at least some embodiments, retraining can be triggered on a schedule like daily, weekly, monthly, etc.

In block 260, in an exemplary inference phase, the trained predictive ML model may be deployed as an exception predictor model to run on each transaction. In at least some embodiments, during the inference phase, trades from the post-transaction (e.g., post-trade) system may be ingested in real time with support for multiple methods (MQ, KAFKA etc.). In at least some embodiments of this disclosure, the inference phase applies the built ML model on each transaction (e.g., trade) and/or predicts a likelihood of failure with probability and/or the predicted reasons for failure. The Exception predictor model runs on each transaction (e.g., trade) at T+0 (the transaction date (e.g., trade date)) and/or provides the likelihood of exception with a probability number.

In at least some embodiments, the present disclosure also provides a) explainability of the probability with the contribution factor of each of the data attribute, underlying reasons and/or b) estimated costs of the exception. The transactions (e.g., trades) may be listed in the order of highest impact and/or likelihood of exception for the settlement team operations to take action.

In at least some embodiments, the present disclosure allows the operational user to look at the underlying reason(s) and/or take action(s) to address the exception. In at least some embodiments, the present disclosure allows flexible configuration for ‘early warning indicators’ based on user defined thresholds of the probability of exception. At least some embodiments may be configured/programmed in a way that an illustrative ML model of the present disclosure provides likelihood of trade) exception for a given transaction (e.g., trade) from T+0 till settlement date. The likelihood of trade) exception for any given transaction (e.g., trade) could vary through its lifecycle.

The resultant outcome from the model may be provided to the consumer of the solution via application programming interface (API) or user interface (UI) or File outputs for consumption and/or actioning.

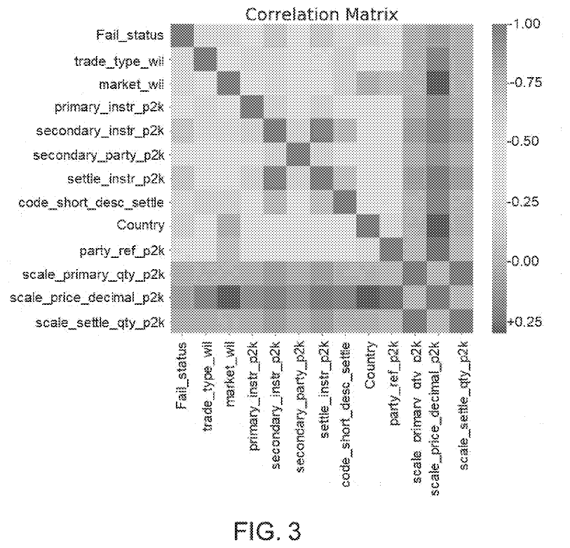

FIG. 3 shows an exemplary correlation matrix between various attributes. The correlation matrix displays the correlation coefficients between multiple attributes. Each cell in the matrix shows the correlation between two attributes, which can range from −1 to +0.25: −1.00 indicates a perfect negative correlation, meaning as one attributes increases, the other decreases.

0.00 indicates no correlation, meaning the attributes do not affect each other.
+0.25 indicates a quarter positive correlation, meaning as one attribute increases, the other also increases by a quarter percentage.

For example, as shown in FIG. 3, the dark shade of a cell between attributes market_wil and scale_price_decimal_p2k indicates a +0.25 correlation, meaning as market_wil attribute increases, scale_price_decimal_p2k attribute also increase by a quarter percentage.

In at least some embodiments, the correlation matrix may be used as a preliminary step in data analysis to understand the data set better before building models like multiple linear regression.

At least some embodiments may be configured/programmed to leverage generative artificial intelligence (GenAI) functionality/interface to support identifying and analyzing the likely probability of any transaction (e.g., trade) failure along with the reason. For example, such GenAI-based embodiments may provide information required to manage post-transaction (e.g., post-trade) operations including exception management, risk analysis, tracking, forecasting, capacity optimization, and research services across front-to-back transaction (e.g., trade) lifecycle management functions. At least some embodiments may be configured/programmed to provide a software as service (SaaS) basis leveraging artificial intelligence to increase operations velocity in settlement efficiency management and/or product control substantiation services. At least some embodiments may be configured/programmed to create end-to-end transaction (e.g., trade) lifecycle event transparency through fragmented transaction (e.g., trade) processing ecosystems to empower its end-users to swiftly remediate, reduce, and/or prevent risks over time. At least some embodiments may be configured/programmed to provide a view on likelihood of a transaction (e.g., trade) failing along with real time information on the transaction (e.g., trade) settlement (e.g., ranking based on risk levels, etc.). At least some embodiments may be configured/programmed to support multiple users to manage their operations by, for example, without limitations, through:
An early warning system that brings the high cost and high likelihood transaction (e.g., trade) failures to the top of operational analyst dashboard for them to act and resolve failures;
Analysis of trends of failure reasons for operations supervisors to put in place process and control to reduce failures.

At least some embodiments may be configured/programmed to provide prediction results that may include probability of failure in percentage term that would provide for the analyst to identify high priority transactions that would need attention. At least some embodiments may be configured/programmed to provide a cost parameter. At least some embodiments may be configured/programmed to provide a list of reason that contributed to mark a transaction (e.g., trade) that is likely to fail. At least some embodiments may be configured/programmed to provide widgets that may be used by users in resolution of exceptions. At least some embodiments may be configured/programmed to provide, based on predictions, top attributes that may be contributing for a transaction to potentially fail.

In exemplary APIs orchestrations, at least some embodiments may be configured/programmed to integrate their components/modules/engines via multiple options including operations console dashboards, APIs, etc. For example, without limitation, there may be APIs that communicate between different layers (e.g., Model Servicing API; and/or Data Services REST API). The exemplary Model Serving API may be a RESTful web service designed for predicting the likelihood of transaction (e.g., trade) failure using, for example, without limitation, a CatBoost machine learning model. In some implementations, the exemplary Model Serving API may utilize Python modules and AWS (Amazon Web Services) SageMaker to integrate with historical transaction (e.g., trade) data to provide real-time predictions. The CatBoost model may be trained on a historical dataset to handle categorical features and complex data relationships, enhancing its accuracy in predicting trade failures.

The exemplary Data Services REST API may be configured/programmed as a RESTful web service for extracting, aggregating and/or presenting data from cloud data warehouse consumption layer in, for example, without limitation, a JSON-readable format. In some embodiments, such API may be built with Python, Flask and/or the Snowflake Python Connector, to seamlessly integrate with, for example, without limitation, Snowflake's cloud data platform to efficiently retrieve and transform data for front-end applications or services. At least some embodiments may be configured/programmed to use standard API requests, applications can interact with the API to initiate data reads and pull the necessary data through different endpoints.

At least some embodiments may be configured/programmed to streamline historical transaction (e.g., trade) data processing within the Fail Predict pipeline. At least some embodiments may be configured/programmed to convert raw comma-separated-values (CSV) formatted documents containing numerous transactions (e.g., trades) into a standardized format. At least some embodiments may be configured/programmed to use, once the conversion is complete, Kafka as a messaging system to integrate with ML module(s) of the exemplary predictor engine. At least some embodiments may be configured/programmed to send the formatted transactions (e.g., trades) to a designated Kafka topic, facilitating asynchronous communication between different components of the pipeline.

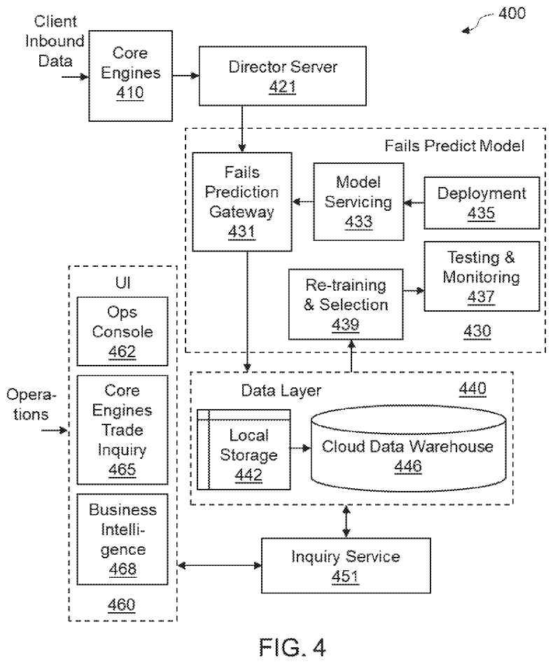

FIG. 4 is a block diagram illustrating an architecture of a fails prediction system 400 in accordance with at least some embodiments of the present disclosure. In at least some embodiments, the fails prediction system 400 may include core engines 410, a director server 421, a fails predict model unit 430, a data layer 440, an inquiry service unit 451 and a UI unit 460.

In at least some embodiments, the core engines 410 may receive client inbound data such as trades and custom formats of the data. The core engines 410 may exemplarily include a first and second processing solution engine, a focused processing engine and a portfolio engine (PE). The first processing solution engine may be a comprehensive securities processing platform that supports a wide range of financial transactions and operations. The second processing solution engine may be another financial processing system, often used for trade processing and settlement. The focused processing engine may be a fixed-income processing engine that provides end-to-end support for fixed-income trading, including trade execution, confirmation, settlement, and accounting. The portfolio engine may be a software tool used in investment management to help manage and optimize investment portfolios. The portfolio engine may exemplarily perform portfolio construction to help in selecting and allocating assets to create a diversified portfolio that aligns with the investor's goals and risk tolerance. The portfolio engine may exemplarily perform risk management by analyzing and monitoring the risk associated with the portfolio, ensuring the portfolio stays within the desired risk parameters. The portfolio engine may exemplarily perform performance tracking by tracking the performance of the portfolio against benchmarks and goals, providing insights into returns and areas for improvement. The portfolio engine may exemplarily perform rebalancing by automatically adjusting the portfolio to maintain the desired asset allocation, especially after market movements. The portfolio engine may exemplarily perform reporting function by generating reports on portfolio performance, risk metrics, and other relevant data for the fails prediction system 400.

In at least some embodiments, the director server 421 may capture trade information in financial information eXchange (FIX) protocol from the portfolio engine 418 and publish the captured trade information in an exchange format, such as Broadridge eXchange (BRx), to the fails predict model unit 430.

In at least some embodiments, the fails predict model unit 430 may include a fails prediction gateway 431, a model serving unit 433, a deployment unit 435, a testing and monitoring unit 437 and a re-training and selection unit 439. The fails prediction gateway 431 may apply a trained ML model to the captured trade information and capture the predictions from the trained ML model. The model servicing unit 433 may deploy the trained ML model into production environments in the fails prediction gateway 431 for making predictions thereby in real-time on the captured trade information. The deployment unit 435 may serve to update the ML model. The testing and monitoring unit 437 may test and monitoring performance of the ML model. The re-training and selection unit 439 may receive new dataset from the data layer 440 for re-training the ML model for up-to-date fails prediction. In some embodiments, multiple ML models may be used for the fails prediction, the re-training and selection unit 439 may select a particular ML model for using with particular trade information.

In at least some embodiments, the data layer 440 may continuously receive and store trade information and predictions from the fails prediction gateway 431 as historical and reference data. The stored data may be provided to the re-training and selection unit 439 to support model features such as re-training the ML models. In some embodiments, the data layer 440 may include a local storage 442 and a cloud data warehouse 446. The local storage 442 may perform raw stage which may involve temporarily storing raw, unprocessed data from the fails prediction gateway 431 before the data undergoes transformation and loading into a cloud data warehouse 446. Trade history and prediction data may also be stored in the local storage 442. The cloud data warehouse may store trade reporting, historical data, reference data, ML models and features. In some embodiments, data transmission from the local storage 442 to the cloud data warehouse may utilize a language associated with the data platform of the cloud data warehouse, such as SnowFlake SQL.

In at least some embodiments, the inquiry service unit 451 may serve as an end points for the UI unit 460. The UI unit 460 may receive operation information with an operations (Ops) console 462. The operation information may include core engines trade inquiries 465 and business intelligence 468.

For data security and/or privacy controls, at least some embodiments may be configured/programmed to provide a protection of private and/or confidential information with strong anonymization, data aggregation and/or encryption. Additionally, embodiments of the model may work on specific client entity's data ensuring data isolation and/or segregation.

At least some embodiments may provide significant benefits to post-trade operations.

At least some embodiments may be configured/programmed to alert the settlement operations and/or optimizes the workload. At least some embodiments may be configured/programmed to address technological (e.g., compute resource-driven) challenges associated with the settlement that may be performed at T+1, especially if exemplary users (e.g., firms) may have geographically distributed operations teams. At least some embodiments may be configured/programmed to reduce operational cost and/or risk and/or enables operations team to address exceptions faster based on the likelihood of transaction (e.g., trade) failure. At least some embodiments may be configured/programmed to provide information for stock loan department with a view of assets (e.g., securities) that need to be borrowed to mitigate, for example without limitation, transaction (e.g., trade) failures and/or cover short sales. At least some embodiments may be configured/programmed to facilitate, for example, without limitation, cash optimization by providing impact from transaction (e.g., trade) fails and/or any other exceptions and/or reduce overdraft fees. At least some embodiments may be configured/programmed to prioritize the transactions (e.g., trades) failure on operational/penalty costs vs. risk of failure dimensions.

In at least some embodiments, the failure or exception predictor supports multiple user personas to better manage their operations. The failure or exception predictor may include an early warning system that brings the high cost and/or high likelihood transactions (e.g., trade) exceptions to the top of operational analyst dashboard for the operational analyst to act and/or resolve failures. Analysis of trends of exception reasons for operations supervisors to put in place process and/or control to reduce failures.

Various embodiments of the present disclosure illustrate systems and methods that may utilize large language model (LLM) driven data querying for response to a user-provided natural language query. The following embodiments provide technical solutions and technical improvements that overcome technical problems, drawbacks and/or deficiencies in the technical fields involving data search scalability when searching across multiple private and/or public data sources, data source integration where each data source typical requires a customized and particular set of tools for interaction, LLM answers that often result in false information delivered as if it were true (commonly referred to as “hallucination”) and/or in violation of rules, standards and/or guidelines. As explained in more detail, below, technical solutions and technical improvements herein include aspects of improved integration of machine learning (ML)-based software agents with one or more LLMs such that the LLM(s) provide orchestration of the ML-based software agents enabling improved scalability of data sources, search and analytics, while the ML-based software agents provide parallel checks and verifications of each other and the LLM to reduce hallucination and non-compliant information. Based on such technical features, further technical benefits become available to users and operators of these systems and methods. Moreover, various practical applications of the disclosed technology are also described, which provide further practical benefits to users and operators that are also new and useful improvements in the art.

In at least some embodiments, the terms “agent” and “software agent” are used interchangeably and refer to a program that may perform at least one task at a particular schedule and/or triggering event with at least some degree of autonomy on behalf of its host and flexibility.

In embodiments, the systems and methods of present disclosure may use an LLM in conjunction with a range of publicly available data, privately available data, and task-specific models to answer user queries questions and assist users in identifying information, trends, themes, insights and/or analytics among other information or any combination thereof. In some embodiments, the described systems and methods may be adapted to one or more different domains.

One such example is financial instrument transacting (e.g., trading). In embodiments of such an example, the systems and methods may use an LLM in conjunction with a range of publicly available data, privately available data, and task-specific models to answer bond-related questions and assist users in identifying assets, themes, and trends. In embodiments of such an example, the systems and methods may inform and expedite vital pricing decisions, facilitates counterparty selection, broadens liquidity access, enhances the often-complex asset selection and portfolio construction processes, and/or provide other improvements to the financial instrument transacting (e.g., trading) domain.

In some embodiments, this architecture leverages the ability of the LLM to interpret and understand a user-provided question and identify the types of information to be queried. This ability can be leveraged to use the LLM to generate instructions to one or more different task-specific models based on the user-provided question in order to orchestrate the task-specific models that are associated with the information being sought, and in turn resulting in a scalable platform of task-specific models whose results can be translated by the LLM into a natural language response to the user for improved data search, data source integration, data analytics and user interfacing. As a result, the systems and methods of the present disclosure enable more complicated user questions that are answered in reduced time and with greater insight, thus providing improved data timeliness and accuracy, and reduced infrastructure costs.

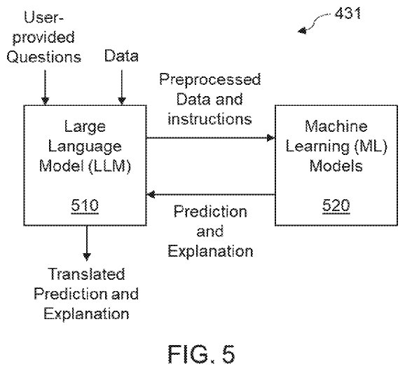

FIG. 5 is a block diagram illustrating an exemplary implementation of the fails prediction gateway 431 integrating a LLM 510 and ML models 520 in accordance with at least some embodiments of the present disclosure. In at least some embodiments, the LLM 510 may receive text data from multiple private and/or public data sources. Each data source may require a customized and particular set of tools for interaction. The LLM 510 may be used to preprocess and clean the text data, making it suitable for the machine learning (ML) models 520. For example, the LLM 510 can handle tasks like tokenization, stemming, and lemmatization, which are essential for preparing the text data. The LLM 510 may also be used to generate embeddings (dense vector representations) for the text data. These embeddings capture semantic information and can be used as features for the ML model 520. For example, embeddings generated by models like BERT or GPT can be fed into classifiers or clustering algorithms.

In at least some embodiments, the LLM 510 can be used for natural language understanding. For example, the LLM 510 may receive user-provided questions in a nature language, and translate the user-provided questions into instructions to select one or more different task-specific ML models 520 in order to orchestrate the task-specific models that associated with the information being sought by the user. As another example, the LLM 510 may also receive predictions and explanations as prediction results from the ML models 520 and translate the prediction results into the natural language response to the user.

Combining the LLM 510 and the ML models 520 can create an integrated system with the LLM 510 being used for natural language understanding, while the ML models 520 can handles specific tasks like fails prediction. The LLM 510 may provide orchestration of the ML models 520 enabling improved scalability of data sources, search and analytics, while the ML models may provide parallel checks and verifications of each other and the LLM 510 to reduce hallucination and non-compliant information. As a result, the integrated system 431 shown in FIG. 5 may improve data search, data source integration, data analytics and user interfacing.

As shown in FIG. 5 with reference to FIG. 4, the LLM 510 may translate the prediction and explanation into the natural language and provide the translated prediction and explanation to the UI unit 460 via the inquiry service unit 451 bypassing the data layer 440. The data layer 440 may store only the untranslated prediction to aggregate historical data for training the ML models 520.

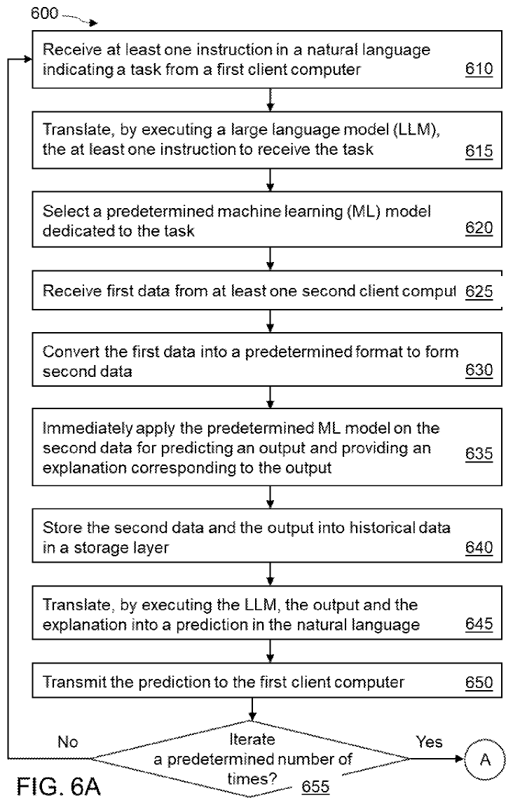

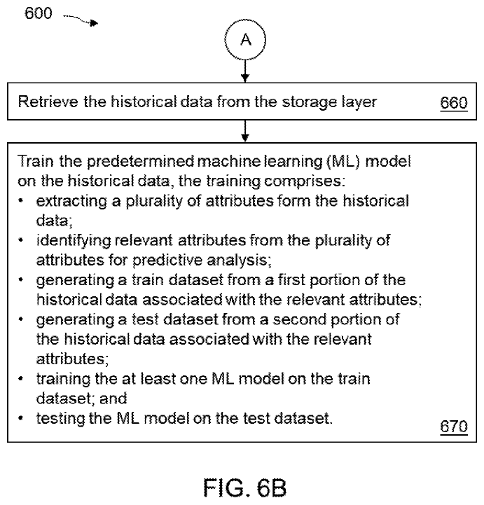

FIGS. 6A and 6B are flowcharts illustrating an exemplary fails prediction process 600 in accordance with at least some embodiments of the present disclosure. In at least some embodiments, the fails prediction process 600 may be divided into a predicting flow depicted by blocks 610-655 and a model training flow depicted by blocks 660-670 as described herein below.

In block 610 of the predicting flow, the fails prediction process 600 may receive at least one instruction in a natural language indicating a task from a first client computer.

In block 615 of the predicting flow, the fails prediction process 600 may translate, by executing a large language model (LLM), the at least one instruction to receive the task.

In block 620 of the predicting flow, the fails prediction process 600 may select a predetermined machine learning (ML) model dedicated to the task.

In block 625 of the predicting flow, the fails prediction process 600 may receive first data from at least one second client computer.

In block 630 of the predicting flow, the fails prediction process 600 may convert the first data into a predetermined format to form second data.

In block 635 of the predicting flow, the fails prediction process 600 may immediately apply the predetermined ML model on the second data for predicting an output and providing an explanation corresponding to the output.

In block 640 of the predicting flow, the fails prediction process 600 may store the second data and the output into historical data in a storage layer.

In block 645 of the predicting flow, the fails prediction process 600 may translate, by executing the LLM, the output and the explanation into a prediction in the natural language.

In block 650 of the predicting flow, the fails prediction process 600 may transmit the prediction to the first client computer.

In block 655 of the predicting flow, the fails prediction process 600 may iterate blocks 610-650 for a predetermined number of times to accumulate sizable historical data. In some embodiments, the predetermined number of times may be equivalent to 12-month worth of trade data. With the sizable historical data the fails prediction process 600 may embark on training the predetermined ML model.

In block 660 of the model training flow, the fails prediction process 600 may retrieve the historical data from the storage layer.

In block 670 of the model training flow, the fails prediction process 600 may train the predetermined machine learning (ML) model on the historical data, the training may include:
extracting a plurality of attributes form the historical data;
identifying relevant attributes from the plurality of attributes for predictive analysis;
generating a train dataset from a first portion of the historical data associated with the relevant attributes;
generating a test dataset from a second portion of the historical data associated with the relevant attributes;
training the at least one ML model on the train dataset; and
testing the ML model on the test dataset.

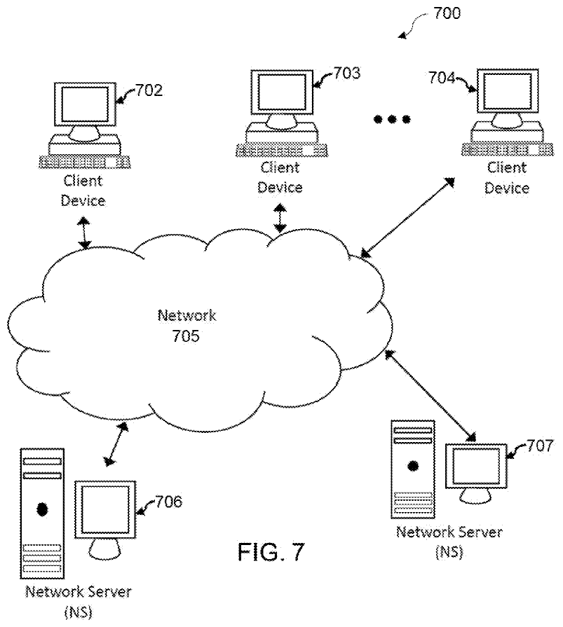

FIG. 7 depicts a block diagram of an exemplary computer-based system and platform 700 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 700 may be configured to manage a large number of members and concurrent transactions, as detailed herein. In some embodiments, the exemplary computer-based system and platform 700 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 7, client device 702, client device 703 through client device 704 (e.g., clients) of the exemplary computer-based system and platform 700 may include virtually any computing device capable of receiving and sending a message over a network (e.g., cloud network), such as network 705, to and from another computing device, such as servers 706 and 707, each other, and the like. In some embodiments, the client devices 702 through 704 may be personal computers, multiprocessor systems, microprocessor-based or programmable consumer electronics, network PCs, and the like. In some embodiments, one or more client devices within client devices 702 through 704 may include computing devices that typically connect using a wireless communications medium such as cell phones, smart phones, pagers, walkie talkies, radio frequency (RF) devices, infrared (IR) devices, CBs citizens band radio, integrated devices combining one or more of the preceding devices, or virtually any mobile computing device, and the like. In some embodiments, one or more client devices within client devices 702 through 704 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, OFDM,

OFDMA, LTE, satellite, ZigBee, etc.). In some embodiments, one or more client devices within client devices 702 through 704 may include may run one or more applications, such as Internet browsers, mobile applications, voice calls, video games, videoconferencing, and email, among others. In some embodiments, one or more client devices within client devices 702 through 704 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a client device within client devices 702 through 704 may be specifically programmed by either Java, . Net, QT, C, C++, Python, PHP and/or other suitable programming language. In some embodiment of the device software, device control may be distributed between multiple standalone applications. In some embodiments, software components/applications can be updated and redeployed remotely as individual units or as a full software suite. In some embodiments, a client device may periodically report status or send alerts over text or email. In some embodiments, a client device may contain a data recorder which is remotely downloadable by the user using network protocols such as FTP, SSH, or other file transfer mechanisms. In some embodiments, a client device may provide several levels of user interface, for example, advance user, standard user. In some embodiments, one or more client devices within client devices 702 through 704 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 705 may provide network access, data transport and/or other services to any computing device coupled to it. In some embodiments, the exemplary network 705 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 705 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 705 may include and implement, as an alternative or in conjunction with one or more of the above, a WiMAX architecture defined by the WiMAX forum. In some embodiments and, optionally, in combination of any embodiment described above or below, the exemplary network 705 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 705 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, OFDM, OFDMA, LTE, satellite and any combination thereof. In some embodiments, the exemplary network 705 may also include mass storage, such as network attached storage (NAS), a storage area network (SAN), a content delivery network (CDN) or other forms of computer or machine readable media.

In some embodiments, the exemplary server 706 or the exemplary server 707 may be a web server (or a series of servers) running a network operating system, examples of which may include but are not limited to Apache on Linux or Microsoft IIS (Internet Information Services). In some embodiments, the exemplary server 706 or the exemplary server 707 may be used for and/or provide cloud and/or network computing. Although not shown in FIG. 7, in some embodiments, the exemplary server 706 or the exemplary server 707 may have connections to external systems like email, SMS messaging, text messaging, ad content providers, etc. Any of the features of the exemplary server 706 may be also implemented in the exemplary server 707 and vice versa.

In some embodiments, one or more of the exemplary servers 706 and 707 may be specifically programmed to perform, in non-limiting example, as authentication servers, search servers, email servers, social networking services servers, Short Message Service (SMS) servers, Instant Messaging (IM) servers, Multimedia Messaging Service (MMS) servers, exchange servers, photo-sharing services servers, advertisement providing servers, financial/banking-related services servers, travel services servers, or any similarly suitable service-base servers for users of the client devices 702 through 704.

In some embodiments and, optionally, in combination of any embodiment described above or below, for example, one or more exemplary computing client devices 702 through 704, the exemplary server 706, and/or the exemplary server 707 may include a specifically programmed software module that may be configured to send, process, and receive information using a scripting language, a remote procedure call, an email, a tweet, Short Message Service (SMS), Multimedia Message Service (MMS), instant messaging (IM), an application programming interface, Simple Object Access Protocol (SOAP) methods, Common Object Request Broker Architecture (CORBA), HTTP (Hypertext Transfer Protocol), REST (Representational State Transfer), SOAP (Simple Object Transfer Protocol), MLLP (Minimum Lower Layer Protocol), or any combination thereof.

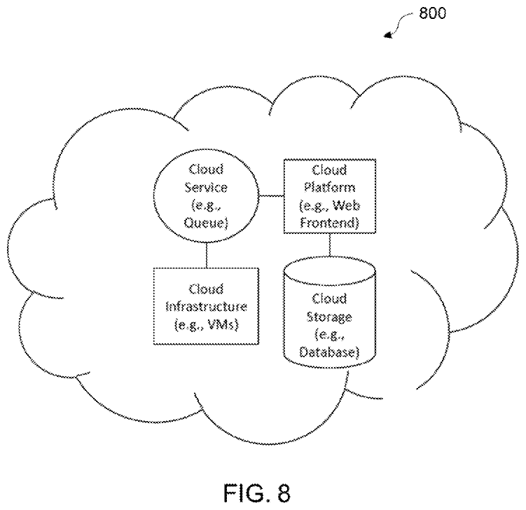

FIG. 8 depicts illustrative schematics of an exemplary implementation of the cloud computing/architecture(s) in which embodiments of a system for AI model training and inferencing may be specifically configured to operate in accordance with some embodiments of the present disclosure. In at least some embodiments, the LLM models resides in the cloud computing system, while the training datasets may be generated in a local computing system and transmitted to the cloud computing system via the Internet. In at least some embodiments, the cloud computing system may be implemented by the network server 706 and/or 707 shown in FIG. 7, while the local computing system may be implemented by the client device 702, 703 and/or 704.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data items, and other suitable data. In some embodiments, as detailed herein, one or more of the computer-based systems of the present disclosure may be implemented across one or more of various computer platforms such as, but not limited to: (1) FreeBSD, NetBSD, OpenBSD; (2) Linux; (3) Microsoft Windows™; (4) OpenVMS™; (5) OS X (MacOS™); (6) UNIX™; (7) Android; (8) iOS™; (9) Embedded Linux; (10) Tizen™; (11) WebOS™; (12) Adobe AIR™; (13) Binary Runtime Environment for Wireless (BREW™); (14) Cocoa™ (API); (15) Cocoa™ Touch; (16) Java™ Platforms; (17) JavaFX™; (18) QNX™; (19) Mono; (20) Google Blink; (21) Apple WebKit; (22) Mozilla Gecko™; (23) Mozilla XUL; (24) .NET Framework; (25) Silverlight™; (26) Open Web Platform; (27) Oracle Database; (28) Qt™; (29) SAP NetWeaver™; (30) Smartface™; (31) Vexi™; (32) Kubernetes™ and (33) Windows Runtime (WinRT™) or other suitable computer platforms or any combination thereof. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

Various detailed embodiments of the present disclosure, taken in conjunction with the accompanying FIGs., are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

In some embodiments, the exemplary inventive computer-based systems/platforms, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
define Neural Network architecture/model,
transfer the input data to the exemplary neural network model,
train the exemplary model incrementally,
determine the accuracy for a specific number of timesteps,
apply the exemplary trained model to process the newly-received input data,
optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

The aforementioned examples are, of course, illustrative and not restrictive.

At least some aspects of the present disclosure will now be described with reference to the following numbered clauses.

In an embodiment, a method comprises: predicting, by at least one computing device, an output and corresponding explanation associated with first data, wherein the predicting comprises: receiving, by at least one computing device, at least one input in a natural language from a first client computer; translating, by the at least one computing device executing a large language model (LLM), the at least one input into at least one task; selecting, by the at least one computing device, at least one predetermined machine learning (ML) model dedicated to the at least one task; receiving, by the at least one computing device, the first data from at least one second client computer; converting, by the at least one computing device, the first data to second data of a predetermined format; immediately applying, by the at least one computing device, the at least one predetermined ML model on the second data for predicting the output and providing the explanation; storing, by the at least one computing device, the second data and the output into historical data in a storage layer; translating, by the at least one computing device executing the LLM, the output and the explanation into a prediction in the natural language; and transmitting, by the at least one computing device, the prediction to the first client computer; iterating, by the at least one computing device, the predicting for a predetermined number of time; retrieving, by at least one computing device, the historical data from the storage layer; and training, by the at least one computing device, the at least one predetermined machine learning (ML) model on the historical data, wherein the training comprises: extracting, by the at least one computing device, a plurality of attributes form the historical data; identifying, by the at least one computing device, relevant attributes from the plurality of attributes for predictive analysis; generating, by the at least one computing device, a train dataset from a first portion of the historical data associated with the relevant attributes; generating, by the at least one computing device, a test dataset from a second portion of the historical data associated with the relevant attributes; training, by the at least one computing device, the at least one predetermined ML model on the train dataset; and testing, by the at least one computing device, the at least one predetermined ML model on the test dataset.

In an embodiment of the method wherein the predicted output indicates a failure associated with the first data.

In an embodiment of the method wherein the train dataset and the test dataset contain equal number of failures.

In an embodiment of the method wherein the predetermined format is an exchange format.

In an embodiment of the method wherein the at least one predetermined ML model is configured as a classification model utilizing one or more of following techniques: Logistic regression, decision trees and random forests, gradient boosting trees, neural networks and/or deep learning techniques, or any combination thereof.

In an embodiment of the method wherein the storage layer comprises a local storage associated with the at least one computing device and a cloud data warehouse.

In an embodiment of the method, wherein the local storage is configured to temporarily store the second data and the prediction.

In an embodiment of the method, wherein the cloud data warehouse is configured to store the historical data.

In an embodiment of the method, wherein the cloud data warehouse is configured to store the at least one predetermined ML model and associated features.

In an embodiment of the method, wherein the second data and the prediction are transmitted to the cloud data warehouse utilizing a language associated with a data platform of the cloud data warehouse.

In an embodiment, the method further comprises: re-training, by the at least one computing device, the at least one predetermined ML model when a performance thereof drifts below a predetermined threshold.

In an embodiment, the method further comprises re-training, by the at least one computing device, the at least one predetermined ML model on a predetermined schedule.

In an embodiment, a system comprises: one or more processors; and a memory in communication with the one or more processors and storing instructions that, when executed by the one or more processors, cause the one or more processors to: predict an output and corresponding explanation associated with first data, wherein the predicting comprises: receiving at least one input in a natural language from a first client computer; translating, by executing a large language model (LLM), the at least one input into at least one task; selecting at least one predetermined machine learning (ML) model dedicated to the at least one task; receiving the first data from at least one second client computer; converting, the first data to second data of a predetermined format; immediately applying the at least one predetermined ML model on the second data for predicting the output and providing the explanation; storing the second data and the output into historical data in a storage layer; translating, by executing the LLM, the output and the explanation into a prediction in the natural language; and transmitting the prediction to the first client computer; iterate the predicting for a predetermined number of time; retrieve the historical data from the storage layer; and train the at least one predetermined machine learning (ML) model on the historical data, wherein the training comprises: extracting a plurality of attributes form the historical data; identifying relevant attributes from the plurality of attributes for predictive analysis; generating a train dataset from a first portion of the historical data associated with the relevant attributes; generating a test dataset from a second portion of the historical data associated with the relevant attributes; training the at least one predetermined ML model on the train dataset; and testing the at least one predetermined ML model on the test dataset.

In an embodiment of the system, wherein the predicted output indicates a failure associated with the first data.

In an embodiment of the system, wherein the train dataset and the test dataset contain equal number of failures.

In an embodiment of the system, wherein the at least one predetermined ML model is configured as a classification model utilizing one or more of following techniques: Logistic regression, decision trees and random forests, gradient boosting trees, neural networks and/or deep learning techniques, or any combination thereof.

In an embodiment of the system, wherein the storage layer comprises a local storage associated with the one or more processors and a cloud data warehouse.

In an embodiment of the system, wherein the local storage is configured to temporarily store the second data and the prediction.

In an embodiment of the system, wherein the cloud data warehouse is configured to store the historical data.

In an embodiment of the system, wherein executing the instructions further causes the one or more processors to re-train the at least one predetermined ML model when a performance thereof drifts below a predetermined threshold or on a predetermined schedule.

Publications cited throughout this document are hereby incorporated by reference in their entirety. While one or more embodiments of the present disclosure have been described, it may be understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

We claim

1. A method, comprising:
predicting, by at least one computing device, an output and corresponding explanation associated with first data, wherein the predicting comprises:
receiving, by at least one computing device, at least one input in a natural language from a first client computer;
translating, by the at least one computing device executing a large language model (LLM), the at least one input into at least one task;
selecting, by the at least one computing device, at least one predetermined machine learning (ML) model dedicated to the at least one task;
receiving, by the at least one computing device, the first data from at least one second client computer;
converting, by the at least one computing device, the first data to second data of a predetermined format;
immediately applying, by the at least one computing device, the at least one predetermined ML model on the second data for predicting the output and providing the explanation;
storing, by the at least one computing device, the second data and the output into historical data in a storage layer;
translating, by the at least one computing device executing the LLM, the output and the explanation into a prediction in the natural language; and
transmitting, by the at least one computing device, the prediction to the first client computer;
iterating, by the at least one computing device, the predicting for a predetermined number of time;
retrieving, by at least one computing device, the historical data from the storage layer; and
training, by the at least one computing device, the at least one predetermined machine learning (ML) model on the historical data, wherein the training comprises:
extracting, by the at least one computing device, a plurality of attributes form the historical data;
identifying, by the at least one computing device, relevant attributes from the plurality of attributes for predictive analysis;
generating, by the at least one computing device, a train dataset from a first portion of the historical data associated with the relevant attributes;
generating, by the at least one computing device, a test dataset from a second portion of the historical data associated with the relevant attributes;
training, by the at least one computing device, the at least one predetermined ML model on the train dataset; and
testing, by the at least one computing device, the at least one predetermined ML model on the test dataset.

2. The method of claim 1, wherein the predicted output indicates a failure associated with the first data.

3. The method of claim 2, wherein the train dataset and the test dataset contain equal number of failures.

4. The method of claim 1, wherein the predetermined format is an exchange format.

5. The method of claim 1, wherein the at least one predetermined ML model is configured as a classification model utilizing one or more of following techniques: Logistic regression, decision trees and random forests, gradient boosting trees, neural networks and/or deep learning techniques, or any combination thereof.

6. The method of claim 1, wherein the storage layer comprises a local storage associated with the at least one computing device and a cloud data warehouse.

7. The method of claim 6, wherein the local storage is configured to temporarily store the second data and the prediction.

8. The method of claim 6, wherein the cloud data warehouse is configured to store the historical data.

9. The method of claim 6, wherein the cloud data warehouse is configured to store the at least one predetermined ML model and associated features.

10. The method of claim 6, wherein the second data and the prediction are transmitted to the
cloud data warehouse utilizing a language associated with a data platform of the cloud data warehouse.

11. The method of claim 1, further comprising re-training, by the at least one computing device, the at least one predetermined ML model when a performance thereof drifts below a predetermined threshold.

12. The method of claim 1, further comprising re-training, by the at least one computing device, the at least one predetermined ML model on a predetermined schedule.

13. A system comprising:
one or more processors; and
a memory in communication with the one or more processors and storing instructions that, when executed by the one or more processors, cause the one or more processors to:
predict an output and corresponding explanation associated with first data, wherein the predicting comprises:
receiving at least one input in a natural language from a first client computer;
translating, by executing a large language model (LLM), the at least one input into at least one task;
selecting at least one predetermined machine learning (ML) model dedicated to the at least one task;
receiving the first data from at least one second client computer;
converting, the first data to second data of a predetermined format;
immediately applying the at least one predetermined ML model on the second data for predicting the output and providing the explanation;
storing the second data and the output into historical data in a storage layer;
translating, by executing the LLM, the output and the explanation into a prediction in the natural language; and
transmitting the prediction to the first client computer;
iterate the predicting for a predetermined number of time;
retrieve the historical data from the storage layer; and
train the at least one predetermined machine learning (ML) model on the historical data, wherein the training comprises:
extracting a plurality of attributes form the historical data;
identifying relevant attributes from the plurality of attributes for predictive analysis;
generating a train dataset from a first portion of the historical data associated with the relevant attributes;
generating a test dataset from a second portion of the historical data associated with the relevant attributes;
training the at least one predetermined ML model on the train dataset; and
testing the at least one predetermined ML model on the test dataset.

14. The system of claim 13, wherein the predicted output indicates a failure associated with the first data.

15. The system of claim 14, wherein the train dataset and the test dataset contain equal number of failures.

16. The system of claim 13, wherein the at least one predetermined ML model is configured as a classification model utilizing one or more of following techniques: Logistic regression, decision trees and random forests, gradient boosting trees, neural networks and/or deep learning techniques, or any combination thereof.

17. The system of claim 13, wherein the storage layer comprises a local storage associated with the one or more processors and a cloud data warehouse.

18. The system of claim 17, wherein the local storage is configured to temporarily store the second data and the prediction.

19. The system of claim 17, wherein the cloud data warehouse is configured to store the historical data.

20. The system of claim 13, wherein executing the instructions further causes the one or more processors to re-train the at least one predetermined ML model when a performance thereof drifts below a predetermined threshold or on a predetermined schedule.
